(19) United States
(12) Patent Application Publication
(10) Pub. No.: US 2025/0043206 A1
(43) Pub. Date: Feb. 6, 2025

(54) Biomass-based Biocharcoals

(71) Applicant: Board of Trustees of Western Michigan University, Kalamazoo, MI (US)

(72) Inventor: Priyanka Sharma, Portage, MI (US)

(21) Appl. No.: 18/794,690

(22) Filed: Aug. 5, 2024

Related U.S. Application Data
(60) Provisional application No. 63/530,508, filed on Aug. 3, 2023.

(51) Int. Cl. C10L 5/44; C10B 53/02; C10B 57/10; C10B 57/14; C10L 9/06

(52) U.S. Cl. CPC C10L 5/442; C10B 53/02; C10B 57/10; C10B 57/14; C10L 9/06; C10L 2200/0469; C10L 2290/02; C10L 2290/08; C10L 2290/28

(57) ABSTRACT

The present disclosure describes a low-energy method of producing biocharcoal from woody and/or non-woody biomass, comprising pretreating the woody and/or non-woody biomass to completely or partially remove lignin, hemicellulose and other non-cellulose components of the biomass; drying the pretreated biomass; and pyrolyzing the dried biomass to produce biocharcoal.

### CROSS REFERENCE TO RELATED APPLICATIONS

This application claims the benefit of U.S. Provisional Application 63/530,508, filed Aug. 3, 2023, the contents of which are incorporated herein by reference in their entirety.

### TECHNICAL FIELD

The present disclosure relates to systems and methods that may be utilized to produce more sustainable green charcoal and cellulose absorbents from non-woody and/or woody biowaste materials such as agricultural and forest plant residues, and/or underutilized biomass, e.g., paper waste.

### BACKGROUND OF THE INVENTION

Biomass waste from various sources (e.g., agriculture, forest residues, etc.) can be efficiently collected and handled onsite for upcycling. The present technology involves the generation of green biocharcoal (GB) from the non-woody and woody biomass sources (e.g., jute fibers, soy hulls, paper waste, saw dust and the like), which may be mechanically processed, in some applications, to increase the surface area of the biomass. This novel technology is a cost-effective and environment-friendly chemical conversion of biomass first into cellulose/lignocellulose hydrogels, which can contain various lignin and hemicellulose content and then heat treatment of the hydrogels, using for example, microwave energy or slow-heating processes to generate GB. Example chemical conversion treatments include using, e.g., acids/bases (HNO₃, H₃PO₄, oxalic acid, H₂SO₄, HCl, and so on), oxidizing agents (NaClO, NaClO₂, TEMPO/NaClO, HNO₃/NaNO₂ and so on), and organic and inorganic solvents (ethanol, polyols, urea, ionic liquids, and so on). Example heat treatments include using a conventional microwave oven (for example at 600 watts), conventional ovens, IR radiation, laser radiation, burning etc. The resultant GBs have an additional benefit of the ability to be custom tailored (i.e., size, porosity, density and various chemical functionalities based on the types and amount of reactive chemical groups) for a variety of purposes, such as filtering, absorption and the like, based on the physical, chemical and heat treatments used to produce the GB.

### SUMMARY OF THE INVENTION

Aspects of the present disclosure may include a low-energy method of producing biocharcoal from woody and/or non-woody biomass, including pretreating the woody and/or non-woody biomass to completely or partially remove lignin, hemicellulose and other non-cellulose components of the biomass; drying the pretreated biomass; and pyrolyzing the dried biomass to produce biocharcoal.

In other aspects pretreating the woody and/or non-woody biomass further includes using acids/bases, oxidizing agents, and/or organic and inorganic solvents to completely or partially remove non-cellulose components of the biomass. In other aspects, pretreating the woody and/or non-woody biomass further comprises converting the biomass into a cellulose hydrogel. In yet others, pretreating the woody and/or non-woody biomass further comprises separating the biomass into smaller components prior to completely or partially removing lignin, hemicellulose and other non-cellulose components of the biomass. In other aspects, separating the biomass into smaller components comprises maceration, grinding, and/or pulverization of the biomass.

In other aspects of the method, drying the pretreated biomass comprises air and/or oven drying. In others, drying the pretreated biomass and pyrolyzing the pretreated biomass may occur simultaneously.

In others, the pretreated biomass comprises a cellulose hydrogel after pretreatment, and wherein the pretreated biomass is dried and pyrolyzed using microwave radiation. In others, pyrolyzing the dried biomass to produce biocharcoal is conducted at temperatures from about 150 to 500° C., from about 150 to 300° C. In others, pyrolyzing the dried biomass to produce biocharcoal is conducted at times ranging from 30 mins to 4 hours, 30 mins to 90 mins.

In other aspects, the method further includes removing ash from the biocharcoal produced by pyrolysis.

In others, the resultant biocharcoal has pore sizes ranging from about 0.1-100 micrometers. In yet others, the resultant biocharcoal has a surface area ranging from 1-5000 m²/g. In others, the resultant biocharcoal has enhanced chemical functionalities from the enriched presence of one or more of additional hydroxyl (OH), carboxyl (COOH, COONa), thiol (SH), amine (NH2), phenolic, anhydroglucose or glucose units compared with high-temperature pyrolysis.

Other features and advantages of the present invention will become apparent from the following detailed description, including the drawing. It should be understood, however, that the detailed description and the specific examples, while indicating preferred embodiments, are provided for illustration only, because various changes and modifications within the spirit and scope of the invention will become apparent to those skilled in the art from the detailed description.

### BRIEF DESCRIPTION OF THE DRAWINGS

The present invention(s) are illustrated by way of example and not limitation with reference to the accompanying drawings, in which like references generally indicate similar elements or features.

FIG. 1 depicts an example aspect and embodiment of the present disclosure on the preparation of green charcoal via a carboxyl functionality cellulose hydrogel using microwave radiation, i.e., 10 mL of 0.5 Wt % of hydrogel;

FIG. 2 depicts an example aspect and embodiment of the present disclosure on the preparation of green charcoal using the cellulose nanocrystals using microwave radiation, i.e., 50 mL of 10 wt % of hydrogel;

FIG. 3 depicts an FTIR of the green charcoal produced from jute fiber cellulose hydrogel example embodiment from Example 1, where 10 mL of cellulose hydrogel (0.5 wt %) underwent microwave treatment;

FIG. 4 depicts an FTIR of the green charcoal produced from jute fiber cellulose hydrogel example embodiment from Example 1, but where 50 mL of cellulose hydrogel (0.5 wt %) underwent microwave treatment;

FIG. 5 depicts a representative biocharcoal sample obtained from pyrolysis of soyhulls using an aspect of the present disclosure;

FIG. 6 depicts representative samples of big- and small-chip biocharcoal produced from cellulose nanocrystal (CNC) hydrogels subject to air and heat drying, with pyrolysis at 500° C. for 60 minutes;

### DETAILED DESCRIPTION

Definitions. The terms used in this specification generally have their ordinary meanings in the art, within the context of this subject matter and in the specific context where each term is used. Certain terms are defined below to provide additional guidance in describing the compositions and methods of the disclosed subject matter and how to make and use them.

As used in the specification and the appended claims, the singular forms “a,” “an,” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per the practice in the art. Alternatively, “about” can mean a range of up to 20%, preferably up to 10%, more preferably up to 5%, and more preferably still up to 1% of a given value. Also, particularly with respect to systems or processes, the term can mean within an order of magnitude, preferably within five-fold, and more preferably within two-fold, of a value.

It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims.

The fate of biomass waste (e.g., agricultural residues and forest residues like seed hulls, straw and sawdust) has mostly been ignored in discussions about mitigating greenhouse gas (GHG) emissions. The use of unsustainable ways to dispose of biomass waste may contribute up to ˜18% of global GHG emissions. Here we disclose unique methods for converting it into a value-added substrate, i.e., green biocharcoal (GB). The effective treatment of biomass, including from woody and non-woody sources, can sequestrate 819.7 MMT CO₂e/year of GHGs, reducing environmental remediation costs while restoring local environmental health.

The potential for GHG sequestration may be via the following significant factors in some aspects of the methods disclosed herein: (i) sustainable upcycling of biomass waste via conversion into activated cellulose hydrogel, (ii) use of an energy-efficient pathway to convert the activated cellulose hydrogel into green charcoal, (iii) utilizing green charcoal for environmental applications, most notably by simultaneous recycling of undesired biomass products (e.g., lignin and hemicellulose) in the first step of treatment. Both current and traditional methods of generating charcoal via pyrolysis do not remove these latter products, which can generate volatile and toxic gases. However, some aspects of the current process disclosed herein do not lead to the generation of such gases.

In general, nonwoody biomass is a more sustainable renewable material compared to woody biomass. Traditionally, nonwoody biomass has not been a source for charcoal, but It can be converted to valuable materials, e.g., activated cellulose adsorbent as well as GB for various applications using aspects of the methods disclosed herein. While aspects of these methods work efficiently on woody biomass as well, other aspects of the present disclosure do not have to rely on valuable forest products to generate GB and can utilize nonwoody as well as woody biomass waste with or without undergoing pyrolysis.

In many aspects of the method, existing or pre-treated woody or non-woody biomass is converted into a cellulose hydrogel, which is then treated with heat to remove water and convert the hydrogel into GB. Aspects of the invention may be tailored based on (1) the type(s) and sizes of biomass being used, and (2) the desired properties of the GB endproduct(s). Biomass sources suitable in aspects of the present disclosure can contain varying content of lignin (1 to 50%) and hemicellulose (0.1-50 wt %) and other components (0.01-5%).

Pre-treatment processes include maceration, grinding, pulverization and the like in order to speed the conversion of the biomass into high-cellulose feedstocks or hydrogels, for example, by increasing the surface area available for chemical attack. In some aspects, the physical structure and chemical composition may be controlled, at least in part, by the structure (e.g., size, shape, fiber length, etc) of the biomass feedstock undergoing the hydrogel process

In addition, aspects of the present disclosure may be tailored toward the presence of particular functional groups on the GBs and cellulose absorbents produced. GBs of the present disclosure may contain one or more functional groups which may enhance their chemical and physical functionalities. In some aspects, functional groups and functionalities of the GB may be produced by adjusting the method of production and the reaction components of the cellulose hydrogel. Several methods of producing cellulose hydrogels are listed in the references cited herein, the contents of which are incorporated by reference. For example, as noted above, chemical treatments include using, e.g., acids/bases (HNO₃, H₃PO₄, oxalic acid, H₂SO₄, HCl, and so on), oxidizing agents (NaClO, NaClO₂, TEMPO/NaClO, HNO₃/NaNO₂ and so on), and organic and inorganic solvents (ethanol, polyols, urea, ionic liquids, and so on). These can produce hydrogels with various properties.

In one example aspect, negative surface charges on the cellulose hydrogels may be generated via the use of HNO₃/NaNO₂, which can add carboxylate groups to the cellulose chains. In another example aspect, use of phosphoric acid to generate hydrocellulose gel may generate a positive charge with the addition of ZnCl₂/Zn(Oac)₂ in the presence of a base to add stable ZnO positive sites electrostatically attached to the cellulose chains.

Additionally, in aspects of present invention, green biocharcoal may be produced through chemical/physical and microwave/thermal treatments, which may allow retention and/or tailoring of various functional groups, relative to pyrolysis processes of the prior art.

Under the less-destructive heating conditions disclosed herein in aspects of the present invention, these sites on cellulose hydrogels may be in whole or in part preserved on the resultant GB, allowing for a range of functionalities in the final product.

For example, not limited to the theory presented here, it is thought that microwave energy will preserve the morphology and charge present in a particular cellulose hydrogel, since, at certain frequencies and voltages, only acts to spin and excite water molecules surrounding the cellulose strands, leaving structure and charge mostly intact. This stands in strong contract to the relatively uncontrolled heating methods of pyrolysis. Other gentle heating methods ore combination of methods are possible as well, such as conventional ovens, IR radiation, laser radiation, burning and the like.

GBs prepared using aspects of the present disclosure can have pore sizes ranging from 0.1-100 micrometers and surface areas of 1-5000 m²/g and chemical functionalities provided by additional hydroxyl (OH), carboxyl (COOH, COONa), thiol (SH), amine (NH₂), phenolic, anhydroglucose or glucose units.

Embodiments of the green charcoal of the present disclosure can be used to build filters, adsorbents, absorbents, composites, membranes, sponges, etc. Compared with pyrolysis, the green biocharcoal production methods disclosed herein may improve energy efficiency by ≤70%, shorten the production cycle by 10-90%, and improve product yield by ˜81% without significantly changing the carbon content of the final product relative to regular charcoals. Most importantly, GHG emissions can be suppressed significantly (≤50%) when whole biochar production uses methods of the present green biocharcoal technology disclosed herein. The preparation time under methods of the present disclosure for green biocharcoal is shorter (1-12 h) compared to conventional charcoal pyrolysis processes, which can range from 1-7 days.

The technology can be further simplified to facilitate adoption by local small communities and industries. Current traditional pyrolysis methods include biocharcoal production primarily performed onsite, where the forest wood is introduced to combustion units at high temperatures. Similarly, aspects of the green charcoal technology can be designed to be mobile to enhance its accessibility in remote areas.

In general, unwanted plant components such as lignins and hemicelluloses may be removed via the pretreatment and oxidation processes during the production of activated hydrogel processes discussed below.

The following illustrative example aspects and embodiments are intended to illustrate the disclosure and are not intended to be limiting.

Example 1: Activated cellulose hydrogel (0.5 wt %) was obtained via an oxidation reaction using nitric acid (60% wt) and sodium nitrite (14 mMol) and mechanical treatment on raw jute fibers (size ˜0.2 microns) at 50° C. for 12 hr under stirring. Then the fiber suspension was filtered to remove the acid and other impurities. The suspension then was defibrillated using a conventional blender The obtained hydrogel contains cellulose (˜90 wt %), hemicellulose (˜35 wt %), and lignin (˜6 wt %) with carboxylic acid functionality of 0.7 mmol/g.

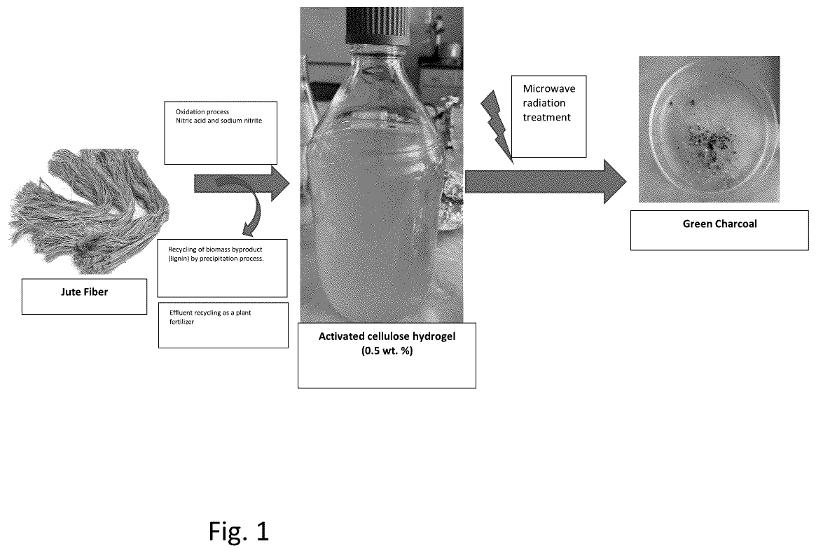

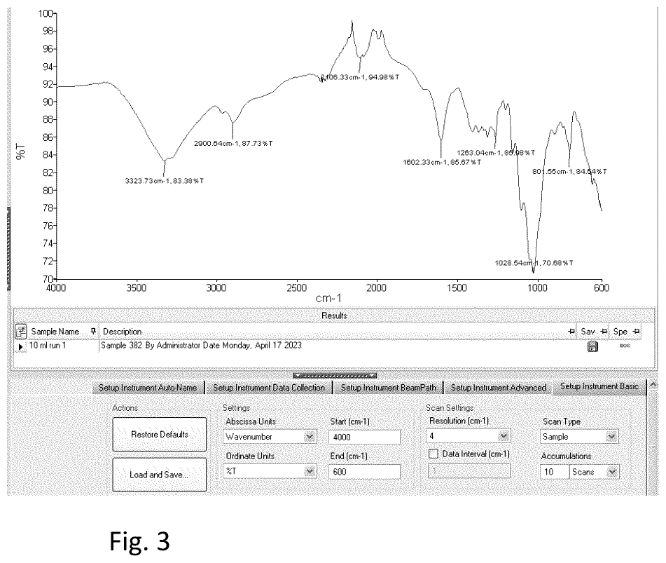

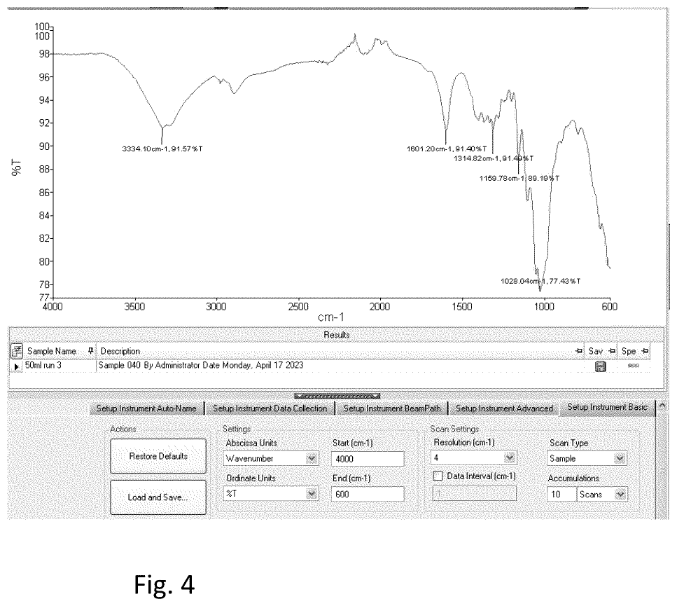

Next, 10 or 50 mL of 0.5 wt % hydrogel underwent microwave radiation in a conventional microwave with a power of 600 watts for 15 minutes (at intervals of 5 minutes; the intervals were 20 s to stir the sample). The obtained product was a dry porous material light brown to dark brown in color (green biocharcoal). It showed the presence of 0.25 mmol/g of carboxylate groups (measured by titration) and a surface area of 525 m²/g (measured by BET instrument). The absence of water peak at 1640 cm-1 in FTIR further confirms the completion of the process for 10 mL of 0.5% wt hydrogel (FIG. 3). FIG. 4 shows the FTIR for the 50 mL 0.5 wt hydrogel. A schematic of the preparation method of green charcoal is shown in FIG. 1.

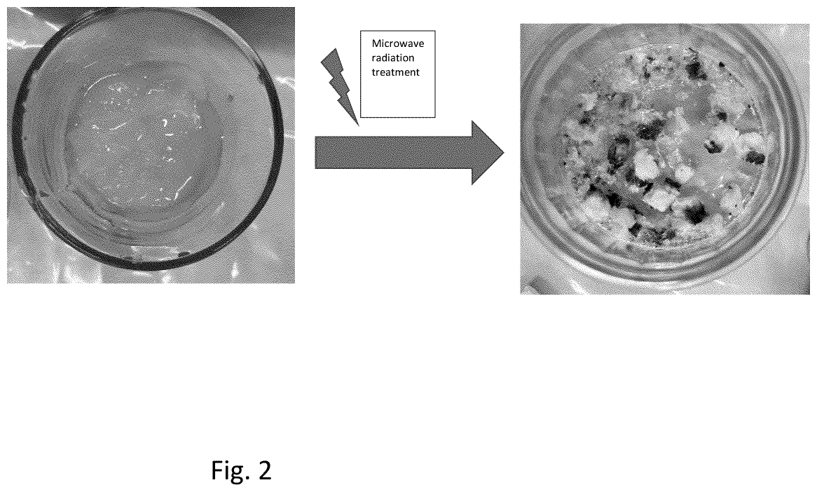

Example 2: To test the ability to make GBs from commercially available, crystalline cellulose hydrogel (e.g., cellulose nanocrystals 10 wt % from the University of Maine), a total of 50 mL of the above was placed into a petri dish and then treated using microwave radiation using a conventional microwave with power of 600 watts for 7 minutes (at the interval of 53 minutes). The obtained scaffold (green charcoal) showed the presence of 0.1 wt % of sulfate groups (measured by elemental analysis) compared to 1.1% in CNC. The surface area measurement using a BET instrument showed 220 m2/g of surface area. The process is shown in FIG. 2.

The chemical functionality of green charcoal produced in Example 1 is shown in FIG. 3. In the spectra, the prominent 3323 cm⁻¹ peak due to the —OH stretching and the weaker 2900 cm⁻¹ peak due to the —CH symmetrical stretching (all from the cellulose component) were present in the green charcoal sample. However, the peak at 1602 cm⁻¹ confirmed the presence of carboxyl group of NOP oxidized carboxy cellulose groups at the C6 position of the anhydroglucose units. This indicates that the microwave irradiation of the hydrogel has not disturbed this peak and is maintained even after treatment. Similar characteristic was obtained for the green charcoal in FIG. 1b. This evidence that green charcoal can be further functionalized into different derivative forms that enhance its applicability.

The density of the obtained charcoal is ˜0.05 g/cm³. As noted above, the chemical functionality in GB has the potential to be used to arise the different charges on the surfaces. For example, the carboxyl group in the above sample has negative surface charge that could be further converted to amide functionality by reacting with amine moiety (e.g., from proteins, urea etc.) The final charcoal with amine functionality can efficiently capture the negative impurities in acidic media through electrostatic interactions.

Example 3: Cellulose nanocrystal hydrogel (10 wt %) was used to prepare the biocharcoal. First the cellulose nanocrystals were air dried. The drying of 100 mL of hydrogel gave ˜10-11 g of cellulose nanocrystals. Both the samples were then introduced to a furnace for 2 hrs at 150° C. The mass of the charcoal obtained was in between 2-2.6 g with yield of 20 and 20.6 wt %.

Example 4. 10 wt % of Cellulose nanocrystal hydrogel was dried using an oven at 70° C. Drying of 100 mL of hydrogel gave ˜10-11 g of cellulose nanocrystals. The samples were individually introduced for pyrolysis at 150° C. for 2 hrs in the presence of air.

The experiments in Examples 3 and 4 repeated twice as shown in table below. The mass of the charcoal obtained were in between 2.4 to 2.5 g with yield of 24 and 25 wt %.

Example 5. TEMPO-oxidized cellulose nanofiber hydrogel (0.6 wt %) was first dried in the air. Air-drying of 200 mL of hydrogel gave ˜1.2 g of sample indicating a 0.6 wt % of sample concentration. The dried sample was then introduced to pyrolysis using a conventional oven for 2 hrs at 150° C. The experiment was repeated twice as shown in table below. The mass of the charcoal obtained were between 0.7 and 0.5 g.

Example 6. The same TEMPO oxidized cellulose nanofibers hydrogel (0.6 wt %) used in the Example 5 were oven-dried. A total of 1.23 g out of 200 mL starting weight was obtained, indicating ˜0.6 wt % concentration of the sample. The sample was then introduced to pyrolysis using a conventional oven for 2 hrs at 150° C. The experiments repeated twice as shown in table below. The mass of the charcoal obtained were in between 0.8-0.3 g.

Example 7. Soyhull powder was introduced to pyrolysis using conventional furnace for 4 h at 300° C. The obtained mass was 0.31 g.

The above Examples 3-7 indicate that if the lignin and hemicellulose are removed and the cellulose fibers length is reduced, these can improve the efficiency of pyrolysis to produce the biocharcoal. The cellulose nanocrystals (Examples 3 and 4) and cellulose nanofibers (Examples 4 and 5) show biocharcoal production even after 2 h and at a low temperature of 150° C. The soyhull powder (non-wood) in Example 6, with hemicellulose (12%), lignin (6%) and protein (11%) showed incomplete pyrolysis at an even higher temperature of 400° C. for 4 h, harsher conditions than what were used for the cellulose nanocrystals and cellulose nanofibers. Additionally, the negative surface charge on cellulose nanocrystals and cellulose nanofibers was maintained in between (−100 to 90 mV), showing that the procedure used to generate green biocharcoal can maintain surficial charges, important for many applications including water purification.

TABLE 1
Drying and pyrolysis conditions of cellulose nanocrystals (CNC),
TEMPO-oxidized cellulose nanofibers (CNF) and Soyhull powder.

| | Biomass Source | | | | | | | | |
|---|---|---|---|---|---|---|---|---|---|
| | CNC | | | | CNF | | | | |
| | Exp. 1 | Exp. 1R | Exp. 2 | Exp. 2R | Exp. 3 | Exp. 3R | Exp. 4 | Exp. 4R | Soy |
| | Air | Air | Oven | Oven | Air | Air | Oven | Oven | Wood |
| Drying Type | (1) | (2) | (1) | (2) | (1) | (2) | (1) | (2) | Exp. 5 |
| Initial Volume (mL) | 100 | 100 | 100 | 100 | 200 | 200 | 200 | 200 | NA |
| Initial Mass (g) | 101.51 | 99.14 | 110.7 | 102.32 | — | — | 196.18 | 197.59 | 5 |
| Dried mass (g) | 10.7 | 10.61 | 11.63 | 10.63 | 1.2 | 1.15 | 1.23 | 1.23 | 5 |
| Dry Time (days) | ~4-5 | ~4-5 | ~1.5 | ~1.5 | ~7 | ~7 | ~1.5 | ~1.5 | NA |
| Amount Burned (g) | 10.7 | — | — | — | — | — | — | 0.5 | 5 |
| Char Product (g) | 2.6 | 2 | 2.5 | 2.4 | 0.7 | 0.5 | 0.8 | 0.3 | 0.31 |
| Burn Time (hr)/ | 2/150 | 2/150 | 2/150 | 2/150 | 2/150 | 2/150 | 2/150 | 2/180 | 4/300 |
| temperature (° C.) | | | | | | | | | |

Example 8. To further investigate the impact of removal of lignin and hemicellulose from non-wood source, pretreated soyhulls were further investigated for pyrolysis. To perform this experiment, the soyhulls were pre-treated using an alkali treatment (i.e., 1 wt % of NaOH).

The pretreatment procedure is summarized below. Soybean Meal was used with a Lignin Content of 2% to 9%; thus, 10.5 g of Soybean Meal will have maximum lignin content of 0.945 g. The meal was treated with 1% NaOH in a Round-Bottom Flask submerged in an oil bath. The reaction took place for 2 hours at 70° C. The resultant product was filtered until the pH reaches 7. The effluent filtrate was treated with 15% HCl until the pH reached 2. Precipitate particles were filtered out and the resultant substrate ˜1.76 g.

As noted above, pretreatment was done using 1% alkali (NaOH) for 2 hrs at 70° C. The analytical measurement of pretreated samples indicates the efficient removal of lignin by ≥90%. The pretreated sample was then introduced to pyrolysis as shown below using the minimal energy. Table 2 below shows the various conditions of pyrolysis investigated using the pretreated soybean samples.

TABLE 2
Conditions of pyrolysis on pretreated Soyhull powder.

| | | Pyrolysis | | Biochar Final Product | | | |
|---|---|---|---|---|---|---|---|
| | Mass | Temperature | Time | Yield | Ash | Biochar | |
| | (Grams) | (° C.) | (Minutes) | (Grams) | (Grams) | (Grams) | Remarks |
| Exp. 1 | 10.01 | 900 | 90 | 0.58 | 0.3 | 2 | |
| Exp. 2 | 10.09 | 300 | 30 | 5.57 | 0.2 | 5.33 | 55% yield |
| Exp. 3 | 10.07 | | 90 | 5.91 | 0.2 | 5.91 | 95% Soybean hull |
| | | | | | | | pyrolyzed |
| Exp. 4 | 10.04 | | 60 | 8.03 | 0.1 | 8.03 | 90% Soybean hull |
| | | | | | | | pyrolyzed |

Experiment 1 involved pyrolyzing the sample in presence of air at 900° C. for 90 minutes. The biocharcoal obtained was 2 g out of 10 g with ash content of 0.3 g; in this case, yield was not good. Hence, for Experiments 2-4, pyrolysis was undertaken at 300° C. for different time, (90, 60 and 30 minutes). The yield improved to ˜50-60%, with the ash amount between 0.1-0.3 g.

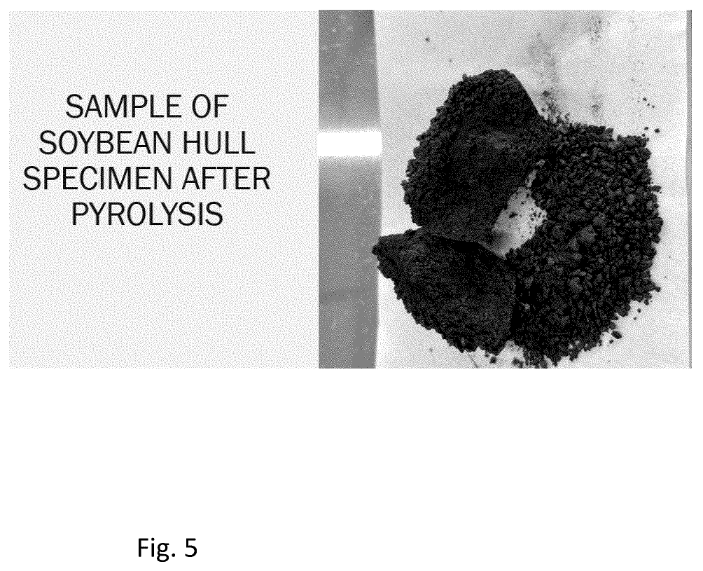

The ash was removed from biocharcoal by dipping it in the water and separating the chunks of charcoal and fine powder (ash) and then drying both the parts separately. The ash content was determined by ASTM E1131-08. The big chunks were biocharcoal and fine powder was ash. A representative biocharcoal obtained from pyrolysis of soyhull is presented in FIG. 5.

The experiments performed indicate that removal of lignin prior to the pyrolysis of plant fibers can increase the efficiency of pyrolysis by reducing the of temperatures and time required to generate biocharcoal.

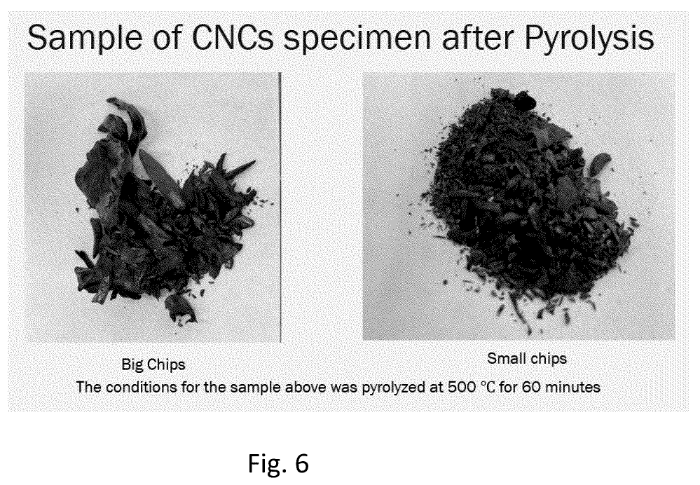

Example 9. Cellulose nanocrystals (CNC) hydrogels were further investigated by first drying them separately using air and oven drying procedure as described in Examples 4-8, leading to a big- and small-chip morphology, respectively. Both types of dried CNC were then introduced to pyrolysis at three different temperatures (e.g., 900, 500 and 300° C.) for 90, 60 and 30 minutes, respectively. When the CNC ‘big chunks’ were heated at 900° C. for 60 minutes, the yield obtained was between 20-30%. Little difference in the physical appearance of biocharcoal was observed in the same material when heated at 500° C. The yield of biocharcoal significantly improved to ˜40% at 300° C. for 60 minutes. The ash generation during this procedure was not significantly high, ≤0.1%. Examples of the biocharcoal obtained from cellulose nanocrystals is shown in FIG. 6. The surface area obtained for CNC prepared at 300° C. and 60 min was 1080 m²/g. Table 3 provides the conditions of pyrolysis and resultant biocharcoals produced.

TABLE 3
Conditions of pyrolysis on cellulose nanocrystals.

| | | Pyrolysis | | Biochar Final Product | | | |
|---|---|---|---|---|---|---|---|
| Mass | | Temperature | Time | Yield | Ash | Biochar | |
| (Grams) | Texture | (° C.) | (Minutes) | (Grams) | (Grams) | (Grams) | Remarks |
| 22.87 | Big chip | 900 | 90 | 3.52 | 0.31 | 3.21 | |
| 9.99 | Big chip | 500 | 60 | 2.38 | 0.01 | 2.37 | |
| 11.01 | Small chip | | | 2.65 | 0.04 | 2.61 | |
| 10.9 | Big chip | | 45 | 2.23 | 0.02 | 2.21 | |
| 10.18 | Small chip | | | 2.34 | 0.01 | 2.33 | |
| 10.15 | Big chip | | 30 | 4.81 | — | — | Incomplete Pyrolysis due |
| 11.06 | Small chip | | | 5.13 | — | — | to Furnace burned out |
| 10.58 | Small chip | 300 | 60 | 4.68 | 0.38 | 4.4 | |
| 10.33 | Small chip | | 45 | 7.88 | — | — | Incomplete Pyrolysis due |
| 9.98 | Small chip | | 30 | 8.01 | — | — | to Furnace burned out |

Aspects of the present disclosure to produce ‘Green Biocharcoal’ are found to be an efficient method to generate the biocharcoal from plant fibers including non-wood sources. These methods focus on removing the subcomponents of lignin and hemicellulose from the plant sources prior to introducing it to pyrolysis procedure, leading to a more open structure in plant fibers and also causing a reduction in H and O content via structural subcomponents (i.e., lignin and hemicellulose).

The extraction process of cellulose fibers before pyrolysis can lead to many benefits. For example: (1) reduction in greenhouse gas (GHG) generation. It is anticipated that the prior removal of subcomponents (i.e., lignin and hemicellulose) which are the source of C, H, O elements will enhance the carbon capture, with the potential to positively impact the environment. (2) The lignin and hemicellulose extraction procedure will open up separate markets for these valuable products, which enhances the market value of whole green biocharcoal process. (3) It improves efficiency: after removal of subcomponents, the left carbon scaffold (i.e., cellulose fibers) can undergo to pyrolysis at low temperature and short time periods.

### REFERENCES

Yousaf, Balal; Liu, Guijian; Abbas, Qumber; Wang, Ruwei; Ubaid Ali, Muhammad; Ullah, Habib; Liu, Ruijia; Zhou, Chuncai. Systematic investigation on combustion characteristics and emission-reduction mechanism of potentially toxic elements in biomass and biocharcoal co-combustion systems. Applied Energy (2017), 208, 142-157.
Walanda, D. K.; Napitupulu, M.; Hamzah, B.; Panessai, K. The capacity of biocharcoal prepared from sawah lettuce plants (Limnocharis flava) as adsorbent of lead ions. Journal of Physics: Conference Series (2020), 1434, 012036.
Rodrigues de Souza, Hiran. Apparatus for production of bio-charcoal and other products. US Pat App Pub. 2009-0053116 A1 (2009 Feb. 26).
Lin, Pei-Xun; Hong, Ming-Quan; Lin, Yi-Xin; Chen, Qi-Ling. Preparation method of soil modifier by converting biomass into bio-charcoal. TW 1563069 B (2016 Dec. 21).
Hill, Steven John; Carson, Adam Christopher. System and method for pyrolysing biomass for producing biochar in continuous process. AU 2021106888 A4 (2021 Nov. 25).
Vasudev, Vikul; Ku, Xiaoke; Lin, Jianzhong. Pyrolysis of algal biomass: Determination of the kinetic triplet and thermodynamic analysis. Bioresource Technology (2020), 317, 124007.
Hassan, Mohd A.; Ahmad Farid, Mohammed A.; Shirai, Yoshihito; Ariffin, Hidayah; Othman, Mohd R.; Samsudin, Mohd H.; Hasan, Mohamad Y. Oil Palm Biomass Biorefinery for Sustainable Production of Renewable Materials. Biotechnology Journal (2019), 14(6).
Park, Deok Gil. Method for manufacturing environment-friendly bio-charcoal using biomass byproduct. KR 2010118865 A (2010 Nov. 8).
Santoso, Rahardi; Hendragiri, Danianto; Garniwa, Iwa. Biomass value improvement and techno-economic analytics in power plan. E3S Web of Conferences (2022), 359, 01008.
Hu, Zhongting; Fei, Yanfei; Wang, Jiade; Ye, Zhiping; Chen, Jinghuan; Wang, Junliang; Ding, Yin; Jin, Ziyan; Chen, Yue. Method for treating heavy metal/organic pollutant composite polluted wastewater by solid waste biomass carbonization material. CN113003648 A (2021 Jun. 22).
Ma, Wenhui; Yang, Xingwei; Wei, Kuixian; Chen, Zhengjie; Wu, Jijun; Dong, Yanqi; Yang, Xi; Xie, Keqiang; Liu, Dachun; Yang, Bin; et al. Method for increasing specific resistance of biomass charcoal reducing agent used for industrial silicon smelting. CN 105253888 A (2016 Jan. 20).
Istiaq Jamil Siddique; Arshad Adam Salema; Elsa Antunes; Ravikrishnan Vinu. Technical challenges in scaling up the microwave technology for biomass processing. Renewable and Sustainable Energy Reviews 153 (2022) 111767.
Sharma, P. R., Joshi, R., Sharma, S. K., Hsiao, B. S. (2017). A simple approach to prepare carboxycellulose nanofibers from raw biomass. Biomacromolecules 18(8), 2333-2342.
Hsiao, B. S., Chu, B., Sharma, P. R. (2021). Production of carboxylated nanocelluloses. U.S. patent Ser. No. 10/894,838.
Sharma, P. R., Chattopadhyay, A., Sharma, S. K., Hsiao, B. S. (2017). Efficient removal of UO₂²⁺ from water using carboxycellulose nanofibers prepared by the Nitro-oxidation method. Ind. Eng. Chem. Res. 56(46), 13885-13893.
Sharma, P. R; Zheng, B.; Sharma, S. K.; Zhan, C.; Wang, R., Bhatia, S.; Hsiao, B. S. (2018). High aspect ratio carboxcelluose nanofibers extracted using nitro-oxidation method and their nanopaper properties. ACS Appl. Nano Mater. 1(8), 3960-3980.
Sharma, P. R.; Sharma, S. K.; Lindstrom, T.; Hsiao, B. S. (2019). Nanocellulose-enabled membranes for water purification: Perspectives. Adv. Sust. Systems 4(5), 1900114.
Das, R., Lindstrom, T., Sharma, P. R., Chi, K., Hsiao, B. S. (2021) Nanocellulose for sustainable water purification. Chem. Rev. 122(9), 8936-9031.
Sharma, P. R.; Huang, X.; Yang, M.; Sharma, S. K.; Hsiao, B. S. (2020) Cellulose nanofibers for sustainable separations in Sustainable separation engineering (Ed. Gyorgy Szekely). Accepted Nov. 30, 2020, Wiley.
Sharma, P. R.; Sharma, S. K.; Hsiao, B. S. Hsiao (2021) Nanocellulose in membrane technology for water purification in Separation of water pollutants with nanotechnology (Ed. Ahuja S.) Accepted June 2021, Newman, Cole (Elsevier).
Sharma, S. K.; Sharma, P. R.; Johnson, K.; Madan, Y.; Li, S.; Cai, G.; Brahmbhatt, I.; Borges, W.; Hsiao, B. S. (2021) Plant-derived carboxycellulose: Highly efficient bionanomaterials for removal of toxic lead from contaminated water in Separation of water pollutants with nanotechnology (Ed. Ahuja S.) Accepted June 2021, Newman, Cole (Elsevier).
Sharma, P. R., Sharma, S. K., Antoine, R., Hsiao, B. (2019). Efficient Removal of Arsenic Using Zinc Oxide Nanocrystal-Decorated Regenerated Microfibrillated Cellulose Scaffolds. ACS Sustain. Chem. Eng. 7, 6, 6140-6151

What is claimed is:

1. A low-energy method of producing biocharcoal from woody and/or non-woody biomass, comprising
pretreating the woody and/or non-woody biomass to completely or partially remove lignin, hemicellulose and other non-cellulose components of the biomass;
drying the pretreated biomass; and
pyrolyzing the dried biomass to produce biocharcoal.

2. The method of claim 1, wherein pretreating the woody and/or non-woody biomass further comprises
using acids/bases, oxidizing agents, and/or organic and inorganic solvents to completely or partially remove non-cellulose components of the biomass.

3. The method of claim 1, wherein pretreating the woody and/or non-woody biomass further comprises
converting the biomass into a cellulose hydrogel.

4. The method of claim 1, wherein pretreating the woody and/or non-woody biomass further comprises
separating the biomass into smaller components prior to completely or partially removing lignin, hemicellulose and other non-cellulose components of the biomass.

5. The method of claim 4, wherein separating the biomass into smaller components comprises maceration, grinding, and/or pulverization of the biomass.

6. The method of claim 1, wherein drying the pretreated biomass comprises air and/or oven drying.

7. The method of claim 1, wherein drying the pretreated biomass and pyrolyzing the pretreated biomass may occur simultaneously.

8. The method of claim 7, wherein the pretreated biomass comprises a cellulose hydrogel after pretreatment, and wherein the pretreated biomass is dried and pyrolyzed using microwave radiation.

9. The method of claim 1, wherein pyrolyzing the dried biomass to produce biocharcoal is conducted at temperatures from about 150 to 500° C.

10. The method of claim 1, wherein pyrolyzing the dried biomass to produce biocharcoal is conducted at temperatures from about 150 to 300° C.

11. The method of claim 1, wherein pyrolyzing the dried biomass to produce biocharcoal is conducted at times ranging from 30 mins to 4 hours.

12. The method of claim 1, wherein pyrolyzing the dried biomass to produce biocharcoal is conducted at times ranging from 30 mins to 90 mins.

13. The method of claim 1, further comprising
removing ash from the biocharcoal produced by pyrolysis.

14. The method of claim 1, wherein the resultant biocharcoal has pore sizes ranging from about 0.1-100 micrometers.

15. The method of claim 1, wherein the resultant biocharcoal has a surface area ranging from 1-5000 m²/g.

16. The method of claim 1, wherein the resultant biocharcoal has enhanced chemical functionalities from the enriched presence of one or more of additional hydroxyl (OH), carboxyl (COOH, COONa), thiol (SH), amine (NH₂), phenolic, anhydroglucose or glucose units compared with high-temperature pyrolysis.
